(19) United States
(12) Patent Application Publication
(10) Pub. No.: US 2006/0258396 A1
(43) Pub. Date: Nov. 16, 2006

(54) Mobile device having broadcast receiving function and telephone communication function

(75) Inventor: Ko Matsuoka, Aichi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sanyo Electric Co., Ltd., Moriguchi City (JP)

(21) Appl. No.: 10/549,303

(22) PCT Filed: Mar. 11, 2004
(86) PCT No.: PCT/JP04/03236

§ 371 Date: Jul. 3, 2006

(30) Foreign Application Priority Data
Mar. 17, 2003 (JP) 2003-072641

(51) Int. Cl. H04M 1/00; H04B 1/38

(52) U.S. Cl. 455/556.1; 455/557; 455/566

(57) ABSTRACT

A mobile apparatus comprising a broadcast receiving function for receiving a television broadcast and a telephone communication function for performing a telephone communication, wherein an audio output device comprising audio output units of two systems, the audio output device outputting a television audio and a telephone-received audio, and an audio processing circuit for outputting the television audio using one of the audio output units of the two systems and outputting the telephone-received audio using the other audio output unit when a telephone communication is performed while the television is continuously viewed/listened to, are provided.

### FIELD OF THE INVENTION

The present invention relates to an information apparatus in which a television receiving function and a communication function are installed.

### BACKGROUND ART

A television phone comprising a television receiving function or a television receiver comprising a television phone function according to a conventional technology is recited in No. 7-184174 of the Publication of the Unexamined Japanese Patent Application.

The conventional technology discloses a structure as shown in FIG. 5, wherein an image pickup camera (2), an input switch (3), an inputted video signal processing device (4), a television antenna (21), television tuner (1), an A/D converter (51), a television image memory (5), a system control circuit (7), codec (15), a memory control circuit (8), a transmitted image buffer memory (9), a received image buffer memory (10), a display control circuit (18), a D/A converter (56), an outputted video signal processing device (19), a display device (20), a line control device (55), a modem (54), an audio processing device (16), an audio receiving device (57), a remote control operating device (52), a remote control photo detecting device (53), and an audio output device (17) are provided.

When a television broadcast is viewed/listened to (ON state of a television power supply), a projected image of the television broadcast is received by the television tuner (1), subjected to processings such as a Y/C separation and filtering in the inputted video signal processing device (4), digitally processed in the A/D converter (51), and then written in the television image memory (5). In parallel with the foregoing operation, data is read from the television image memory (5) by the display control circuit (18), and the read data is converted into an analog signal by the D/A converter (56), and then transmitted to the display device (20) via the outputted video signal processing device (19) to be thereby displayed.

Upon the arrival of an incoming call at the television phone in the foregoing state, the line control device (55) notifies the system control circuit (7) of the arrival of the incoming call. The line control device (55) then controls the audio processing device (16) to thereby lower a sound volume of the television broadcast to a set value, and further makes the audio output device (17) output a ring tone. The system control circuit (7) is notified of the arrival of the incoming call and immediately transmits a command for outputting an incoming-call message to the display control circuit (18).

The display control circuit (18) reads a corresponding message data from an internal text memory upon the receipt of the command, and then superposes the read message data on image data read from the television image memory (5) and outputs the resulting data. The message is displayed in an upper part, a lower part, a sub screen (window) or the like of a screen, and may be displayed any other way in accordance with software change.

When an operator (viewer/listener) presses a on-hook button of the remote control operating device (52) in order to answer the incoming call, a corresponding remote control signal (incoming call answering signal) is received by the system control circuit (7) via the remote control photo detecting device (53) of a television main body. The system control circuit (7) transmits the received incoming call answering signal to the line control device (55) and the display control circuit (18). The line control device (55) connects lines and controls the audio processing device (16) to thereby halt the ring tone in response to the receipt of the incoming call answering signal. Thereafter, the line control device (55) outputs a received caller's voice/sound to the audio output device (17) via the audio processing device (16). The display control circuit (18) halts the output of the incoming-call message and displays a received caller's image on the sub screen (window).

The received caller's image is separated from audio data in the line control device (55) and transmitted to the codec (15) via the modem (54) and the system control circuit (7) to be decoded therein. The decoded data is then written in the received image buffer memory (10) by the memory control circuit (8). The data written in the received image buffer memory (10) is read by the display control circuit (18) and superposed on the image data read from the television image memory (5). Then, the resulting data is outputted to the D/A converter 56 and thereby displayed on the sub screen of the display device (20).

An image to be transmitted to the other end in the telephone communication is inputted by the camera (2), and an audio to be transmitted thereto is inputted via a microphone incorporated in the remote control operating device (52). The image inputted via the camera (2) is digitally processed in the A/D converter (51) via the input switch (3) and the input video signal processing device (4), and then written in the transmitted image buffer memory (9). The image data written in the transmitted image buffer memory (9) is read by the memory control circuit (8) and transmitted to the codec (15) to be compressed/coded therein. Then, the resulting data is transmitted via the system control circuit (7), modem (54) and line control device (55).

A user's own sound/voice picked up via the microphone incorporated in the remote control operating device (52) is transmitted to the television main body in a manner similar to or the same as in a cordless telephone. An audio signal transmitted from the remote control operating device (52) is received by the audio receiving device (57). The audio signal received by the audio receiving device (53) is subjected to a processing such as coding by the audio processing device (16) and transmitted via the line control device (55).

In the case of performing the communication using the television phone while continuously viewing/listening to the television, it is necessary to output both of the television audio and the telephone audio. In the foregoing conventional technology, the sound volume of the television is lowered, while the sound volume of the telephone is turned up so that the both can be heard.

However, it is difficult for the viewer/listener to catch the lowered television audio in the foregoing conventional technology.

Further, a disadvantage in the case of applying the aforementioned audio output method to the mobile apparatus is that a third party in vicinity of the mobile apparatus suffers a very annoying noise.

Therefore, a main object of the present invention is to determine which of the television and the telephone is prioritized depending on the viewer/listener's request and to realize an audio output method suitable for the mobile apparatus and making it easier to catch the sound/voice and an image display method.

### DISCLOSURE OF THE INVENTION

A mobile apparatus according to the present invention is a mobile apparatus comprising a broadcast receiving function for receiving a television broadcast and a telephone communication function for performing a telephone communication, wherein an audio output device comprising audio output units of two systems, the audio output device outputting a television audio and a telephone-received audio, and an audio processing circuit for outputting the television audio using one of the audio output units of the two systems and outputting the telephone-received audio using the other audio output unit when a telephone communication is performed while the television is continuously viewed/listened to, are provided.

A setting means for setting which of the audio output units of the two systems is used for outputting the television audio and the telephone-received audio in the case of performing the telephone communication while continuously viewing/listening to the television, is preferably provided.

A sound volume ratio control means for controlling a ratio of sound volumes of the audio output units of the two systems in the case of performing the telephone communication while continuously viewing/listening to the television, is preferably provided. Further, a setting means used by a user for setting the sound volume ratio is preferably provided.

As an example of the sound volume ratio control means is used a device for controlling the sound volume ratio so that the sound volume of the telephone-received audio is higher than the sound volume of the television audio.

A display device for displaying a television image and a telephone-received image and a display control means for displaying both of the television image and the telephone-received image on the display device in the case of performing the telephone communication while continuously viewing/listening to the television, are preferably provided.

As an example of the display control means is used a device for window-displaying one of the television image and the telephone-received image in a displayed image of the other.

As an example of the display control means is used a device for dividing a display screen into two regions and displaying the television image in one of the divided display regions and the telephone-received image in the other region.

A setting means used by the user for setting sizes and display positions of the television image and the telephone-received image displayed on the display device is preferably provided.

Examples of the audio output device include an earphone, headphone and the like.

When the mobile apparatus according to the present invention is used, the user can simultaneously perform both of viewing and listening to the television and the telephone communication, and can perform the communication real time without bothering the other party in the communication using the television phone. As another advantage, the user can make a telephone call without halting viewing/listening to the television, which is advantageous for a broadcast station because the television is continuously viewed/listened to by the user. Further, the mobile apparatus according to the present invention is very convenient because the television audio and the telephone-received audio can be distinguished via L and R channels.

In the case of performing the telephone communication while continuously viewing/listening to the television, it can be set which of the audio output units of the two systems is used for outputting the television audio and the telephone-received audio. Therefore, one of the audios having a higher priority can be outputted to the user on his/her listening-ear side.

Further, in the case of performing the telephone communication while continuously viewing/listening to the television, the ratio of the sound volumes of the audio output units of the two systems can be controlled, and the user can set the sound volume ratio. Therefore, the sound volume ratio can be adjusted so that the sound volume of the telephone-received audio is higher than the sound volume of the television audio, and the user can preferentially listen to the telephone-received audio while continuously listening to the television audio.

Further, in the case of performing the telephone communication while continuously viewing/listening to the television, one of the television image and the telephone-received image can be window-displayed in the displayed image of the other, and the display screen can be divided into two regions so that the television image is displayed in one of the divided regions and the telephone-received image is displayed in the other region. Further, the user can optionally set the sizes and the display positions of the two images, which allows each individual user to simultaneously display the images of the two types in a most desirable form.

Further, the earphone or the headphone can be used as the audio output device. Thereby, the user can enjoy both of viewing/listening to the television and the telephone communication without bothering the third party in vicinity with the annoying sound. Further, the user can advantageously listen to only one of the two audios that he/she desires to concentrate on by simply removing the earphone or the headphone outputting the other audio, for example, in such a case that he/she wishes to temporarily concentrate on the telephone communication.

### BRIEF DESCRIPTION OF THE DRAWINGS

FIG. 1 is a block diagram illustrating a constitution of a mobile apparatus according to an embodiment of the present invention.

FIG. 2 is a schematic view of an external appearance of the mobile apparatus shown in FIG. 1.

FIG. 3 is a flow chart according to the embodiment of the present invention.

FIGS. 4(a) and 4(b) are schematic views of other display methods of a display device according to the embodiment of the present invention.

FIG. 5 is a block diagram illustrating a constitution of a mobile apparatus according to a conventional technology.

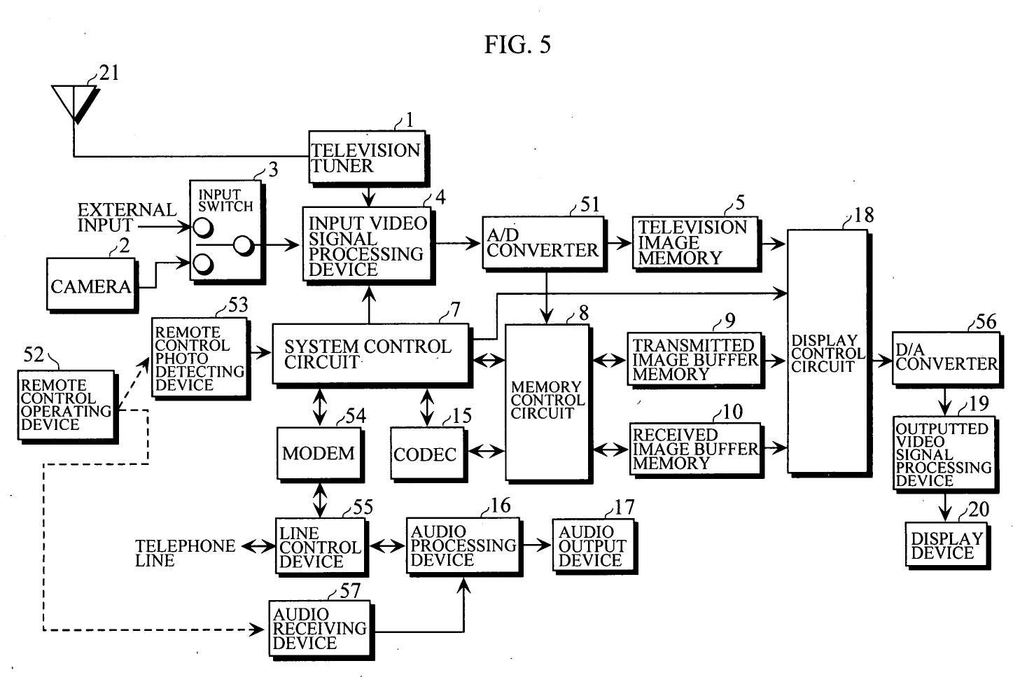

### BEST MODE FOR CARRYING OUT THE INVENTION

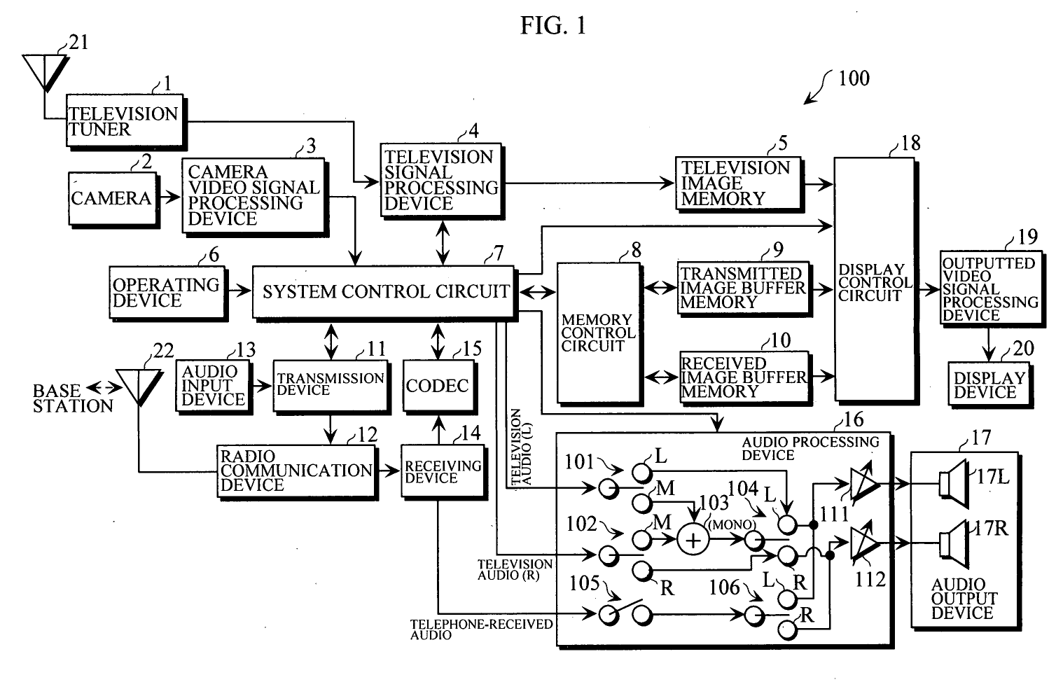

Hereinafter, an embodiment of the present invention is described referring to FIGS. 1 through 4.

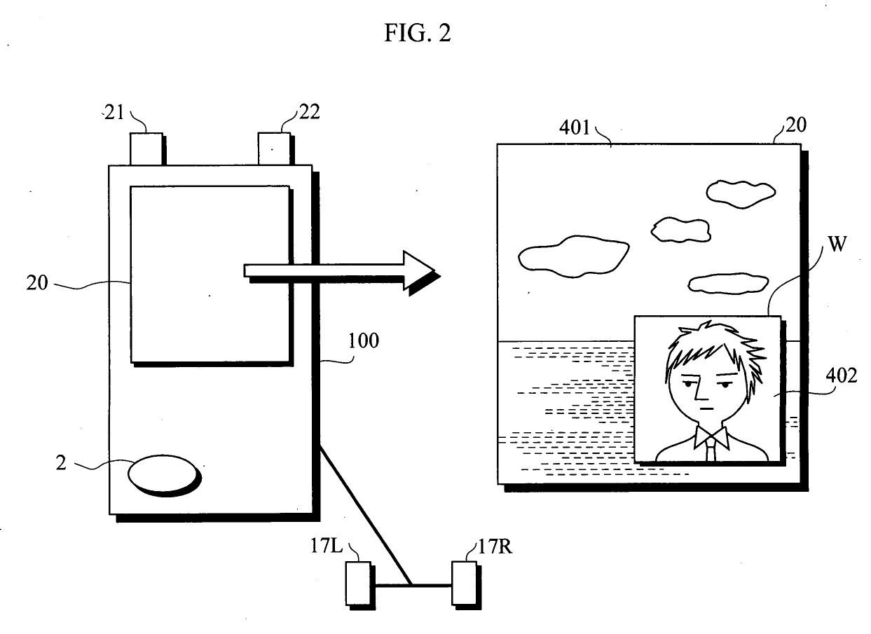

FIG. 1 illustrates a constitution of a mobile apparatus 100 according to an embodiment of the present invention. FIG. 2 shows an external appearance of the mobile apparatus 100. The mobile apparatus 100 comprises a broadcast receiving function for receiving a television broadcast and a telephone communication function for performing a telephone communication.

The mobile apparatus 100 comprises, in order to view/listen to the television, a television antenna (21), a television tuner (1), a television signal processing device (4), a television image-memory (5), a display control circuit-(18), an output video signal processing device (19), a display device (20), an operating device (6), a system control circuit (7), an audio processing device (16), and an audio output device (17).

The mobile apparatus 100 further comprises, for a telephone, particularly for a television phone function, a television antenna (22), a camera (2), a camera video signal processing device (3), an audio input device (13), a transmission device (11), a radio communication device (12), a receiving device (14), a codec (15), a system control circuit (7), a memory control circuit (8), a transmitted image buffer memory (9), a received image buffer memory (10), a display control circuit (18), an outputted video signal processing device (19), a display device (20), an audio processing device (16), an audio output device (17), and an operating device (6).

Below is described an operation of the mobile apparatus in the case of a television reception. A television signal received via the television antenna (21) is channel-selected in the television tuner (1). A channel to be inputted for the channel selection is designated by the operating device (6) having a numeric keyboard functioning as a channel button. The numeric keyboard of the operating device (6) is also used as a numeric keyboard for inputting a telephone number. The channel-selected television signal is subjected to processings such as a Y/C separation, filtering and the like by the television signal processing device (4). In the case where the channel-selected television broadcast is an analog broadcast, the video signal is digitally processed and written in the television image memory (5).

In parallel with the foregoing operation, image data is read from the television image memory (5) by the display control circuit (18) and converted into a video signal by the output video signal processing device (19). Then, the video signal is displayed on the display device (20) comprising an LCD panel or an organic panel.

Referring to audio, audio signals (left-channel signal L and right-channel signal R) are separated from the channel-selected television signal by the television signal processing device (4) and transmitted to the audio output device (17) comprising a headphone, a earphone or a speaker via the system control circuit (7) and the audio processing device (16) to be outputted. In the present example, the audio output device (17) comprises a left-channel speaker (17L) and a right-channel speaker (17R) for convenience of description.

Next is described a telephone operation. When an outgoing telephone call is made, a telephone number of a person receiving the call is designated in the operating device (6), and an outgoing-call button on the operating device (6) is pressed. In the case of receiving an incoming telephone call, the incoming call is answered through the operation of an incoming-call button on the operating device (6). The audio signal to be transmitted to the other end is inputted from the audio input device (13) comprising a microphone and a peripheral circuit of the microphone such as a microphone amplifier, and converted into a signal format in the transmission device (11) in accordance with a communication system known as a CDMA system, a TDMA system or the like. The resulting signal is subjected to a modulation and a frequency up-conversion by the radio communication device (12), and thereafter transmitted to a base station as a radio signal via the telephone antenna (22).

In the case of the television phone, the camera (2) photographs an image of a user. A video signal picked up by the camera (2) is converted into a digital signal by the camera video signal processing device (3) and subjected to processings such as amplification, filtering and the like. The resulting signal is then transmitted to the codec (15) via the system control circuit (7). The codec (15) codes the transmitted image signal into a format suitable for the telephone communication. In the coding process, a coding format, such as JPEG in the case of a still image and MPEG in the case of a moving image, is generally used.

The coded image signal is converted into the signal format in accordance with the communication system known as the CDMA system or the TDMA system in the transmission device (11), and subjected to the modulation and the frequency up-conversion by the radio communication device (12) together with the aforementioned audio signal. The resulting signal is then transmitted as the radio signal via the telephone antenna (22).

In the case of receiving a signal from the other end in the communication, the radio signal received via the telephone antenna (22) is down-converted by the radio communication device (12) and is subjected to a decoding process suitable for the CDMA or TDMA signal as the communication system of the mobile telephone by the receiving device (14). The decoded audio signal is transmitted to the audio output device (17) via the audio processing device (16) and outputted.

In the case of the television phone, the image signal decoded in accordance with the communication system such as the CDMA or TDMA by the receiving device (14) is decoded in accordance with the signal format such as the JPEG or MPEG by the codec (15). The decoded image signal is written in the received image buffer memory (10) via the system control circuit (7) and the memory control circuit (8). At that time, the image to be transmitted to the other end can be written in the transmitted image memory (9) via the system control circuit (7) and the memory control circuit (8). The memory control circuit (8) switches to and from the writing operations with respect to the transmitted image buffer memory (9) and the received image buffer memory (10).

The display control circuit (18) reads the image data from one of or both of the transmitted image buffer memory (9) and the received image buffer memory (10) in accordance with an instruction from the system control circuit (7). The read image data is converted into the video signal by the output video signal processing device (19), and thereafter displayed on the display device (20) comprising the LCD panel or the organic EL panel.

Next, the audio processing device (16) is described. In FIG. 1, an L-channel signal of the television audio is inputted to a first switch (101). The first switch (101) serves to switch its piece to an L contact (L) or an M contact (M). When the television is viewed/listened to, the piece of the first switch (101) is switched to the L-contact (L) side and transmitted to a gain variable amplifier (111) for the left channel via an L contact (L) of a third switch (104) described later.

An R-channel signal of the television audio is inputted to a second switch (102). The second switch (102) serves to switch its piece to an R contact (R) or an M contact (M). When the television is viewed/listened to, the piece of the second switch (102) is switched to the R-contact (R) side and transmitted to a gain variable amplifier (112) for the right channel via an R contact (R) of the third switch (104) described later.

The M contact (M) of the first switch (101) and the M contact (M) of the second switch (102) are connected to a synthesizing circuit (103) for generating a monaural signal of the television audio. The third switch (104) is connected to an output terminal of the synthesizing circuit (103).

The telephone-received audio is connected to a fourth switch (106) via an ON/OFF switch (105). The fourth switch (106) serves to switch its piece to an L contact (L) or an R contact (R).

When there is an incoming telephone call through the television phone and both of the television audio and the telephone-received audio are outputted while the television is viewed/listened to, the piece of the first switch (101) and the piece of the second switch (102) are switched to the M-contact (M) side. Therefore, the L-channel signal and the R-channel signal of the television audio are transmitted to the synthesizing circuit (103) to be synthesized therein. Thereby, the monaural signal of the television audio is generated. The monaural signal outputted from the synthesizing circuit (103) is transmitted to the third switch (104).

On the other hand, the telephone-received audio signal is transmitted to the fourth switch (106) via the ON/OFF switch (105). The third switch (104) and the fourth switch (106) are controlled so that one of them is switched to the L-contact (L) side and the other is switched to the R-contact (R) side. For example, the piece of the third switch (104) is switched to the R-contact (R) side, while the piece of the fourth switch (106) is switched to the L-contact (L) side.

When the third switch (104) and the fourth switch (106) are thus controlled, the monaural signal of the television audio is transmitted to the right-channel speaker (17R) via the gain variable amplifier (112) for the right channel, while the telephone-received audio signal is transmitted to the left-channel speaker (17L) via the gain variable amplifier (111) for the left channel. At that time, the amplifiers (111) and (112) are controlled so that, for example, the monaural signal of the television audio is reduced and the telephone-received audio signal is increased.

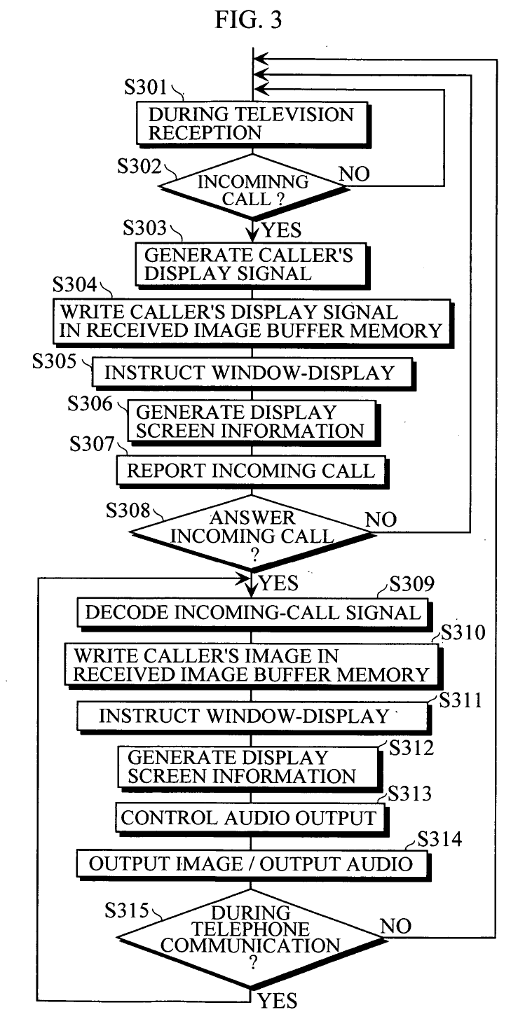

Next, below is described the arrival of an incoming call at the television phone at the time of viewing/listening to the television referring to a flow chart of FIG. 3.

When there is no incoming call (Step S302) in the television reception (when the television is viewed/listened to) (Step S301), the television reception is continued. When there is an incoming call (Step S302) in the television reception (Step S301), the arrival of the incoming call is reported.

More specifically, telephone book data memorized in a memory not shown is searched according to a caller's telephone number so that information relating to the caller is read. The caller's telephone number is generated as a caller's display signal when there is no information relating to the caller, while the caller's image or name as his/her information is generated as the caller's display signal when there is the information relating to the caller (Step S303). The caller's display signal is written in the received image buffer memory (10) (Step S304).

The system control circuit (7) instructs the window display (Step S305), and the caller's information displayed in the window (Step S306). At the same time, the arrival of the incoming call is reported through a combination of different reporting methods such as a lingual sound and a vibration (Step S307).

In the case of not answering the incoming call (Step S308), the incoming call is disconnected by some kind of operation such as pressing the power-supply key of the operating device (6) so that the window is closed and the television can be continuously viewed/listened to. Alternatively, the incoming call can be ignored so that the caller breaks the connection or the incoming call is neglected so that the base station or terminal automatically disconnects the incoming call after a certain period of time (for example, 30 seconds) has passed. Thereby, the television can be continuously viewed/listened to.

In the case of answering the incoming call (Step S308), the incoming-call button on the operating device (6) is operated in order to answer the incoming call. As a result of the operation, the received signal is decoded by the receiving device (14) and the codec (15) (Step S309), and the received image transmitted from the other end in the communication is written in the received image buffer memory (10) (Step S310). The system control circuit (7), for example, opens a window W on the display device (20) as shown in FIG. 2, and outputs an instruction for displaying the received image in the window W to the display control circuit (18) (Step S311).

In response to the receipt of the instruction, the display control circuit (18) reads the image information from the received image buffer memory (10) and the television image memory (5), and, as shown in FIG. 2, opens the window W in the television image to thereby generate the image data forming the telephone-received image (Step S312). In FIG. 2, a reference numeral 401 denotes the television image, and a reference numeral 402 denotes the telephone-received image.

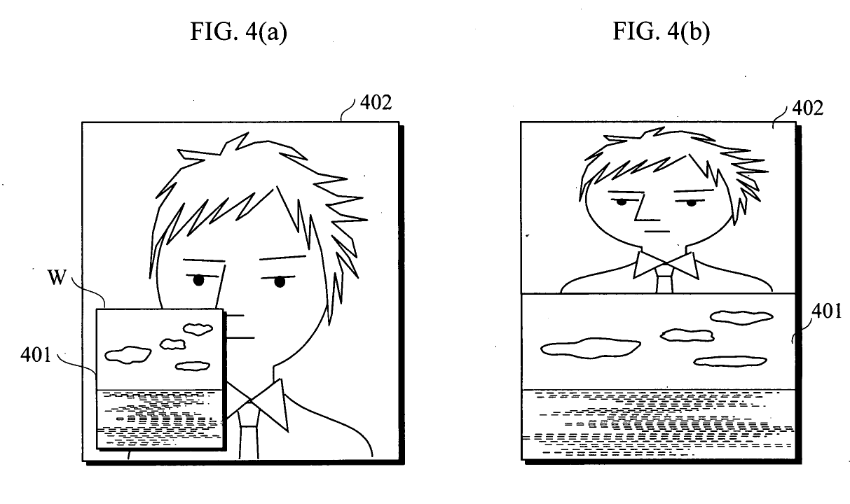

The image is not necessarily displayed as shown in FIG. 2. As shown in FIG. 4(a), the window W may be opened in the telephone-received image 402 on the contrary to the constitution shown in FIG. 2 so that the television image 401 is displayed therein. As a different method, the display screen may be divided into two regions so that the television image 401 is displayed in one of the regions and the telephone-received image 402 is displayed in the other region as shown in FIG. 4(b).

In response to the receipt of the instruction from the system control circuit (7), the audio processing device (16) controls the audio output (Step S313). More specifically, one of the television audio and the telephone-received audio is outputted from the left-channel speaker 17L, while the other is outputted from the right-channel speaker 17R, and further, the respective sound volumes are separately adjusted.

In the foregoing manner, the images and the audios are outputted (Step S314). At that time, for example, the telephone audio is outputted to the L channel, while the television audio is outputted to the R channel, and further, the sound volume of the R channel as the television audio lower than the sound volume of the L channel as the telephone audio is outputted. For example, the sound volume ratio between R and L is 3:7. The user may optionally set the ratio by operating the operating device 6. Alternatively, the R and L channels may be selectively used in such manner that the R channel is in charge of the telephone audio and the L channel is in charge of the television audio, which is particularly convenient when the user is viewing/listening to the mobile television using the headphone.

The user may optionally determine the sizes and the display positions of the television image and the telephone image in the display device by operating the operating device (6).

1. A mobile apparatus comprising:
a broadcast receiving function for receiving a television broadcast; and
a telephone communication function for performing a telephone communication, wherein
an audio output device comprising a left-channel audio output unit and a right-channel audio output unit, and
an audio processing circuit for outputting a left-channel signal of a television audio to the left-channel audio output unit and outputting a right-channel signal of the television audio to the right-channel audio output unit when a telephone communication is not performed and the television is viewed and listened to, the audio processing circuit further generating a monaural television audio signal from the left-channel signal and the right-channel signal of the television audio, outputting a monaural television audio using one of the left-channel and right-channel audio output units and outputting a telephone-received audio using the other audio output unit in the case of performing the telephone communication at the time of viewing/listening to the television, are provided.

2. A mobile apparatus as claimed in claim 1, wherein
a setting means for setting which of the audio output units is used for outputting the television audio and the telephone-received audio in the case of performing the telephone communication at the time of viewing/listening to the television, is provided.

3. A mobile apparatus as claimed in claim 1, wherein
a sound volume ratio control means for controlling a ratio of sound volumes of the two audio output units in the case of performing the telephone communication at the time of viewing/listening to the television, is provided.

4. A mobile apparatus as claimed in claim 3, wherein
a setting means used by a user for setting the sound volume ratio is provided.

5. A mobile apparatus as claimed in claim 3, wherein
the sound volume ratio control means controls the sound volume ratio so that the sound volume of the telephone-received audio is higher than the sound volume of the television audio.

6. A mobile apparatus as claimed in claim 1, wherein
a display device for displaying a television image and a telephone-received image and a display control means for displaying both of the television image and the telephone-received image on the display device in the case of performing the telephone communication at the time of viewing/listening to the television, are provided.

7. A mobile apparatus as claimed in claim 6, wherein
the display control means window-displays one of the television image and the telephone-received image in a displayed image of the other.

8. A mobile apparatus as claimed in claim 6, wherein
the display control means divides a display screen into two regions and displays the television image in one of the divided display regions and the telephone-received image in the other region.

9. A mobile apparatus as claimed in claim 7, wherein
a setting means used by the user for setting sizes and display positions of the television image and the telephone-received image displayed on the display device is provided.

10. A mobile apparatus as claimed in claim 1, wherein
the audio output device is an earphone or a headphone.
